(19) United States
(12) Patent Application Publication
(10) Pub. No.: US 2026/0003974 A1
(43) Pub. Date: Jan. 1, 2026

(54) ALTERNATE MEMORY SPACE FOR EVALUATING DATABASE COMMANDS

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 19/178,157

(22) Filed: Apr. 14, 2025

Related U.S. Application Data
(60) Provisional application No. 63/664,544, filed on Jun. 26, 2024.

(51) Int. Cl. G06F 21/57; G06F 21/54; G06F 21/62

(52) U.S. Cl. CPC G06F 21/577; G06F 21/54; G06F 21/6227

(57) ABSTRACT

Novel tools and techniques are provided for implementing an alternate memory space for evaluating database commands. In various examples, in response to receiving database commands, a computing system may execute the database commands in an alternate memory portion of a data storage system, the alternate memory portion being separated from a main memory portion of the data storage system. The computing system may evaluate, in some cases using an artificial intelligence (“AI”) system, results of the executed database commands to determine whether the results pass rule sets for interacting with the data storage system. If the results pass, the computing system may merge the alternate memory portion with the main memory portion such that the results of the executed database commands are reflected in the main memory portion. If the results do not pass, the computing system may block and discard the set of database commands.

### CROSS-REFERENCE TO RELATED APPLICATIONS

This application claims the benefit of U.S. Provisional Application No. 63/664,544 filed Jun. 26, 2024, entitled “Alternate Memory Space for Evaluation Database Commands,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing database access functionalities, and, more particularly, to methods, systems, and apparatuses for implementing alternate memory space for evaluating database commands.

### BACKGROUND

Many data storage systems are vulnerable to injection-type attacks (e.g., structured query language (“SQL”)-injection attacks), which are capable of corrupting data, destroying data, exfiltrating data, and/or bypassing database security systems. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing an alternate memory space for evaluating database commands, in accordance with various embodiments.

FIG. 2 depicts an example sequence flow for implementing an alternate memory space for evaluating database commands, in accordance with various embodiments.

FIGS. 3A-3E depict flow diagrams illustrating an example method for implementing an alternate memory space for evaluating database commands, in accordance with various embodiments.

FIGS. 4A-4E depict flow diagrams illustrating another example method for implementing an alternate memory space for evaluating database commands, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a computing system may, in response to receiving a set of database commands that is directed to a data storage system, execute the set of database commands in an alternate memory portion of the data storage system, the alternate memory portion being separated from a main memory portion of the data storage system. The computing system may evaluate, in some cases using an artificial intelligence (“AI”) system based on an AI model, results of the executed set of database commands to determine whether the results pass rule sets for interacting with the data storage system. Based on a determination that the results pass the rule sets for interacting with the data storage system, the computing system may merge the alternate memory portion with the main memory portion such that the results of the executed set of database commands are reflected in the main memory portion. Based on a determination that the results do not pass the rule sets for interacting with the data storage system, the computing system may block and discard the set of database commands and/or may return at least one of an error or an empty dataset. In some examples, the computing system may alternatively or additionally add a user sending the set of database items or an IP address from which the set of database items is sent to a deny list. Alternatively or additionally, the computing system may log a failed attempt by the user or from the IP address.

In this manner, data storage systems may be protected from unauthorized changes or changes that adversely affects data stored in main memory of the data storage systems, based on testing whether requested changes (in the form of database statements or queries, etc.) pass some rule sets. Accordingly, injection-type attacks or similar attacks—which utilize database statements or queries as attack vectors and which are capable of corrupting data, destroying data, exfiltrating data, and/or bypassing database security systems, etc.—may be mitigated or blocked.

These and other aspects of the alternate memory space (also referred to herein as alternate memory portion or alternate memory overlay) for evaluating database commands are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system, a set of database commands that is directed to a data storage system; and executing, by the computing system, the set of database commands in an alternate memory portion of the data storage system, the alternate memory portion being separated from a main memory portion of the data storage system. The method further includes evaluating, by the computing system, results of the executed set of database commands to determine whether the results pass rule sets for interacting with the data storage system. The method further includes, based on a determination that the results pass the rule sets for interacting with the data storage system, merging, by the computing system, the alternate memory portion with the main memory portion such that the results of the executed set of database commands are reflected in the main memory portion. Alternatively, the method further includes, based on a determination that the results do not pass the rule sets for interacting with the data storage system, blocking and discarding, by the computing system, the set of database commands.

In another aspect, the technology relates to a system, including an artificial intelligence (“AI”) system and a computing system. The computing system includes a processing system and memory coupled to the processing system. The memory includes computer executable instructions that, when executed by the processing system, causes the system to perform operations including: receiving a set of database commands that is directed to a data storage system; executing the set of database commands in an alternate memory portion of the data storage system, the alternate memory portion being separated from a main memory portion of the data storage system; evaluating, using the AI system and based on an AI model, results of the executed set of database commands to determine whether the results pass rule sets for interacting with the data storage system; and performing one of: based on a determination that the results pass the rule sets for interacting with the data storage system, merging, by the computing system, the alternate memory portion with the main memory portion such that the results of the executed set of database commands are reflected in the main memory portion; or based on a determination that the results do not pass the rule sets for interacting with the data storage system, blocking and discarding, by the computing system, the set of database commands.

In yet another aspect, the technology relates to a method, including receiving, by a computing system, a set of database commands that is directed to a data storage system; establishing, by the computing system, an alternate memory portion in the data storage system, the alternate memory portion being separated from a main memory portion of the data storage system; and mirroring, by the computing system, database items stored in one or more segments of the main memory portion within corresponding one or more segments of the alternate memory portion. The method further includes setting, by the computing system, the alternate memory portion, instead of the main memory portion, as an initial memory space for executing database commands; and executing, by the computing system, the set of database commands in the alternate memory portion of the data storage system. The method further includes evaluating, by the computing system and using the AI system based on an AI model, results of the executed set of database commands to determine whether the results pass rule sets for interacting with the data storage system, by determining whether the results of the executed set of database commands either conform to previously identified normal patterns in database commands, conform to previously identified deviations in normal patterns in database commands, or deviate from both the previously identified normal patterns and the previously identified deviations in normal patterns. The method further includes, based on a determination that the results conform to previously identified normal patterns in database commands, merging, by the computing system, the alternate memory portion with the main memory portion such that the results of the executed set of database commands are reflected in the main memory portion. Alternatively, the method further includes, based on a determination that the results of the executed set of database commands either conform to previously identified deviations in normal patterns in database commands or deviate from both the previously identified normal patterns and the previously identified deviations in normal patterns, performing at least one of: blocking and discarding, by the computing system, the set of database commands; or returning, by the computing system, at least one of an error or an empty dataset.

Various modifications and additions can be made to the embodiments discussed without departing from the scope of the invention. For example, while the embodiments described above refer to particular features, the scope of this invention also includes embodiments having different combinations of features and embodiments that do not include all of the above-described features.

### Specific Exemplary Embodiments

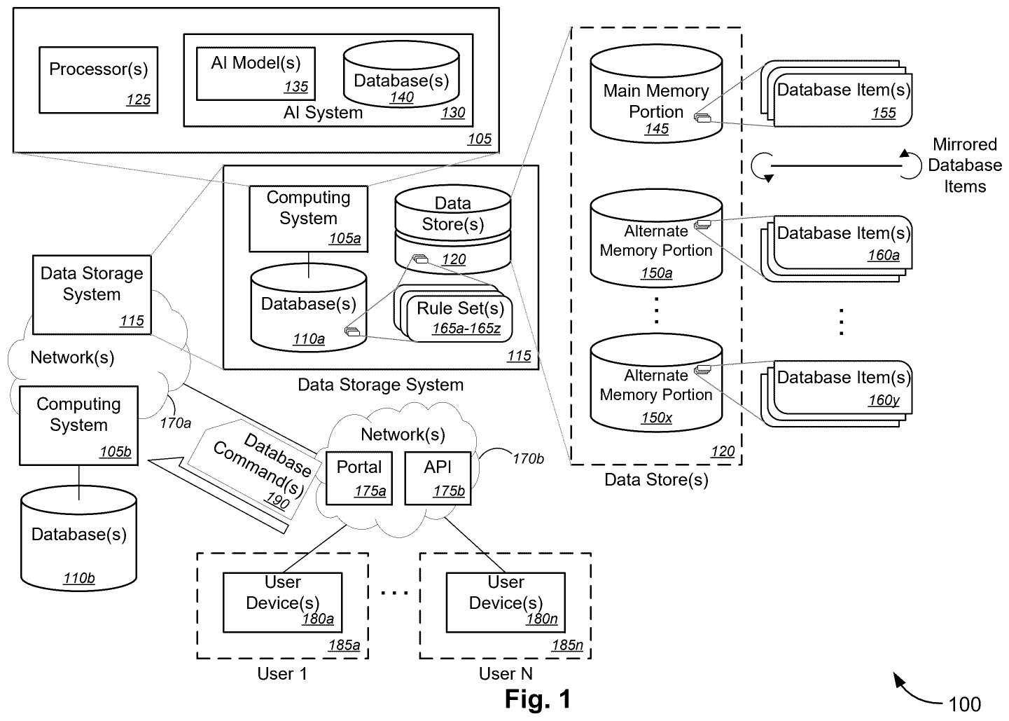

We now turn to the embodiments as illustrated by the drawings. FIGS. 1-5 illustrate some of the features of the method, system, and apparatus for implementing database access functionalities, and, more particularly, to methods, systems, and apparatuses for implementing alternate memory space for evaluating database commands, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing an alternate memory space for evaluating database commands, in accordance with various embodiments. In the non-limiting example of FIG. 1, system 100 may include computing system 105, corresponding database(s) 110, and data storage system 115. In some instances, computing system 105 includes at least one of a computing system 105a (and corresponding database(s) 110a) that is part of (e.g., disposed within or integrated with) data storage system 115 or a remote/external computing system 105b (and corresponding database(s) 110b) that is external to, yet communicatively coupled with, data storage system 115, and/or the like. In some embodiments, data storage system 115 may further include data store(s) 120. In examples, computing system 105a and 105b may each include a processor(s) 125 and an artificial intelligence (“AI”) system 130. In some instances, the AI system 130 includes one or more AI models 135 that are generated, updated, and/or used by the AI system 130 to perform the functionalities described herein. AI system 130 further includes one or more databases 140 that may be used to store at least one of the one or more AI models 135, training data, and/or machine learning (“ML”) algorithms for training the one or more AI models 135 based on the training data, and/or the like.

In examples, the data store(s) 120 may include a main memory portion 145, on which may be stored a plurality of database items 155, and one or more alternate memory portions 150a-150x (collectively, “alternate memory portions 160” or “memory portions 160”), on each of which is stored a plurality of database items 160a-160y. As used herein, “database items” may refer to data, data structures, files, documents, and/or the like, that may be stored in a database, data storage device or system, or a data repository, or the like. “Alternate memory portions” (also referred to herein as “alternate memory overlay” or “alternate memory space”), as used herein, may refer to portions of the memory of the data storage system that are separated (and, in some cases, at least temporarily isolated) from the main memory, where database commands (e.g., database queries, database statements, etc.) may be tested or evaluated against rule sets (as described in detail below) without affecting data or database items stored in the main memory. As used herein, the alternate memory portions being “separated” from the main memory refers to either logical separation and/or physical separation from the main memory. In some instances, one or more first segments of the plurality of database items 160a mirror corresponding one or more segments of the plurality of database items 155. Likewise, one or more second segments of each of the plurality of database items 160b-160(y−1) mirror corresponding one or more segments of the plurality of database items 155. Similarly, one or more third segments of the plurality of database items 160y mirror corresponding one or more segments of the plurality of database items 155. In some cases, the first, second, and third segments are the same and correspond to the same segments of the plurality of database items 155, where the segments of the plurality of database items 155 are smaller than the entire set of data items 155 stored in the main memory portion 145. In other cases, each of the first, second, or third segments is different from at least one other of the first, second, or third segments. In some instances, the first, second, and/or third segments may be mirrored portions of the entire set of database items 155 stored in the main memory portion 145.

In some examples, the computing system 105a may include, without limitation, at least one of a data storage orchestrator, a database management system, a database administrator system, a memory manager, and/or a server, and/or the like. In some cases, computing system 105b may include, but is not limited to, at least one of a data storage orchestrator, a database management system, a database administrator system, a memory manager, and/or a server, a cloud computing system, and/or a distributed computing system, and/or the like. As used herein, “AI system” may refer to a system that is configured to perform one or more artificial intelligence functions, including, but not limited to, machine learning functions, deep learning functions, neural network functions, expert system functions, and/or the like. Herein also, tasks performed by an AI system (in some cases, using the one or more ML algorithms) are also known as “AI tasks” and/or “ML tasks,” which may refer to one or more artificial intelligence tasks including, but not limited to, machine learning tasks, deep learning tasks, neural network tasks, expert system tasks, and/or the like. “ML algorithms” (also referred to as “AI algorithms” or “AI/ML algorithms”) may refer to one or more artificial intelligence algorithms including, but not limited to, machine learning algorithms, deep learning (“DL”) algorithms, neural network (“NN”) algorithms, expert system (“ES”) algorithms, and/or the like. By contrast, non-AI/ML tasks may refer to any tasks that are performed by a computing system without using any artificial intelligence algorithms. Herein, tasks without specific reference to either AI/ML tasks or non-AI/ML tasks may refer to either or both. In examples, the data storage system 115 may include a relational database (e.g., a structured query language (“SQL”)-based database system, or the like) or a non-relational database (e.g., a NoSQL database system, or the like), or the like. Relational database may refer to a database that stores data in tabular form, where each column may represent a specific data attribute while each row may represent an instance of that data, with identifiers being used to relate rows with other rows in the table, or to relate between tables. Non-relational database may include key-value databases, document databases, or graph databases, or the like. Key-value databases store data as a collection of key-value pairs where a key serves as a unique identifier, while document databases store data as JSON objects that, by their nature, are flexible, semi-structured, and hierarchical, and graph databases store data as data entities and data edges that describe the relationship between two entities.

According to some embodiments, system 100 may further include rule sets 165a-165z (collectively, “rule sets 165”), which may be stored in one or both of database(s) 110a/110b or data store(s) 120. The rule sets 165 define rules for interactions between users 185a-185n (in the form of database commands or user inputs that may be converted into database commands) and the data storage system 115. System 100 may further include network(s) 170a and/or 170b, a portal 175a, application programming interface (“API”) 175b, and one or more user devices 180a-180n (collectively, “user devices 180”) associated with corresponding one or more users 185a-185n (collectively, “users 185”). Herein, n or N, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In some instances, the user device(s) 180 may each include, but is not limited to, one of a desktop computer, a laptop computer, a tablet computer, a smart phone, a mobile phone, or any suitable device capable of communicating with network(s) 170a and/or 170b or with servers or other network devices within network(s) 170a and/or 170b, or via any suitable device capable of communicating with at least one of the computing system(s) 105a or 105b, and/or the data storage system 115, and/or the like, via a web-based portal (e.g., portal 175a, or the like), an API (e.g., API 175b), a server, a software application (“app”), or any other suitable communications interface, or the like (not shown), over network(s) 170a and/or 170b. In some cases, users 185 may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

According to some embodiments, networks 170a and 170b may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 170a and 170b may include an access network of the service provider (e.g., an Internet service provider (“ISP”)). In another embodiment, the networks 170a and 170b may include a core network of the service provider and/or the Internet.

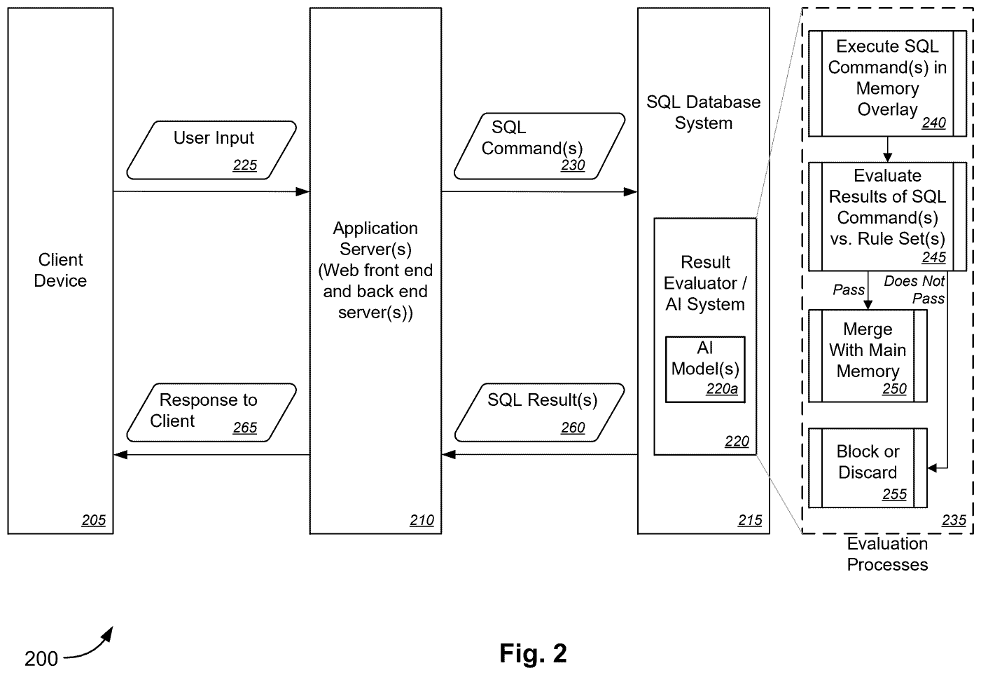

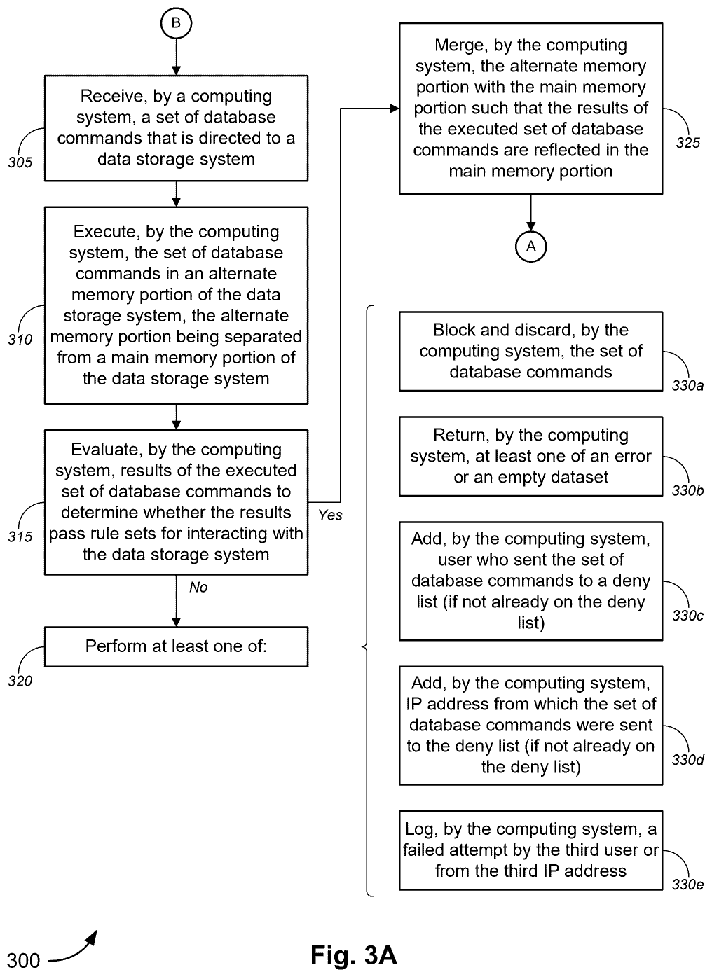

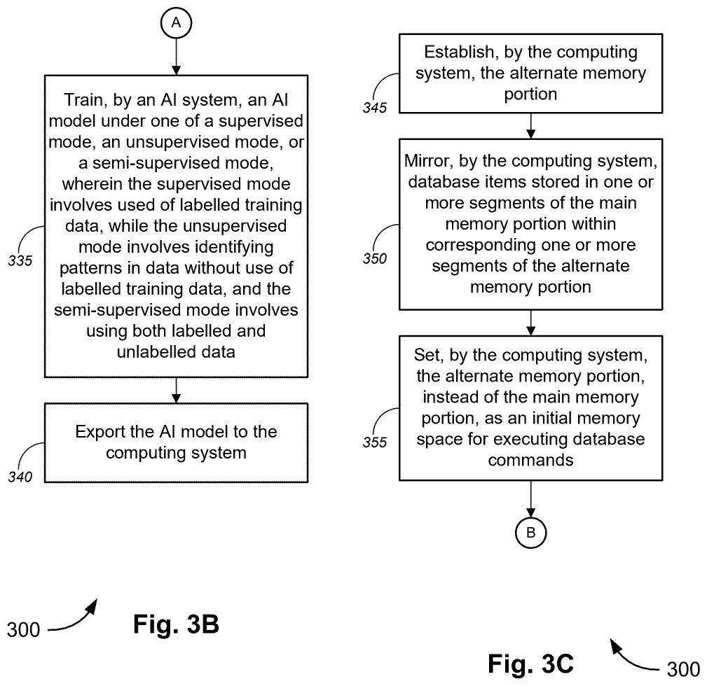

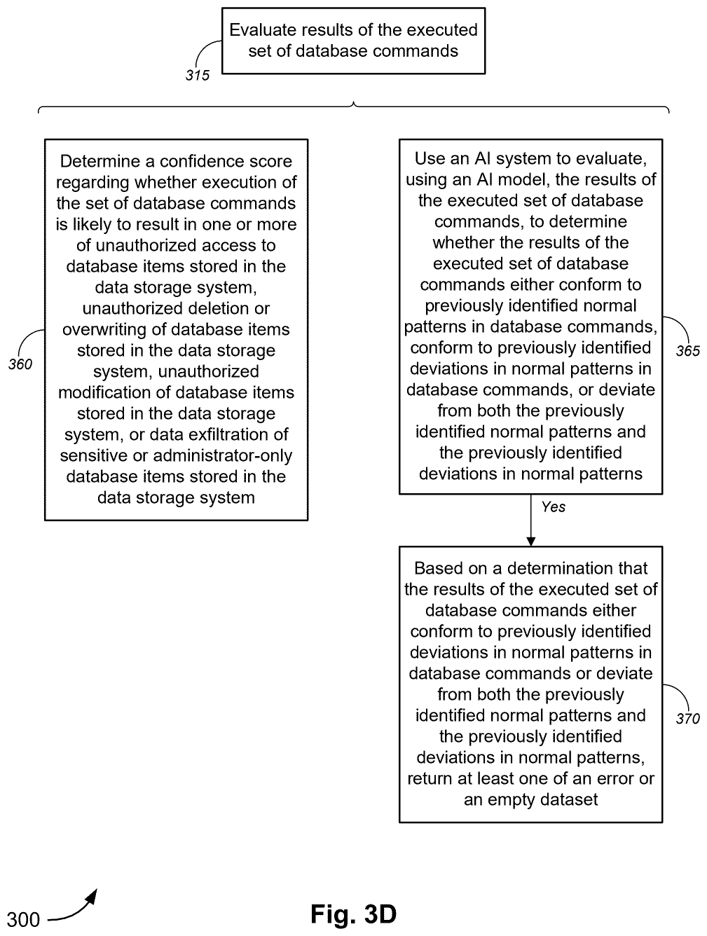

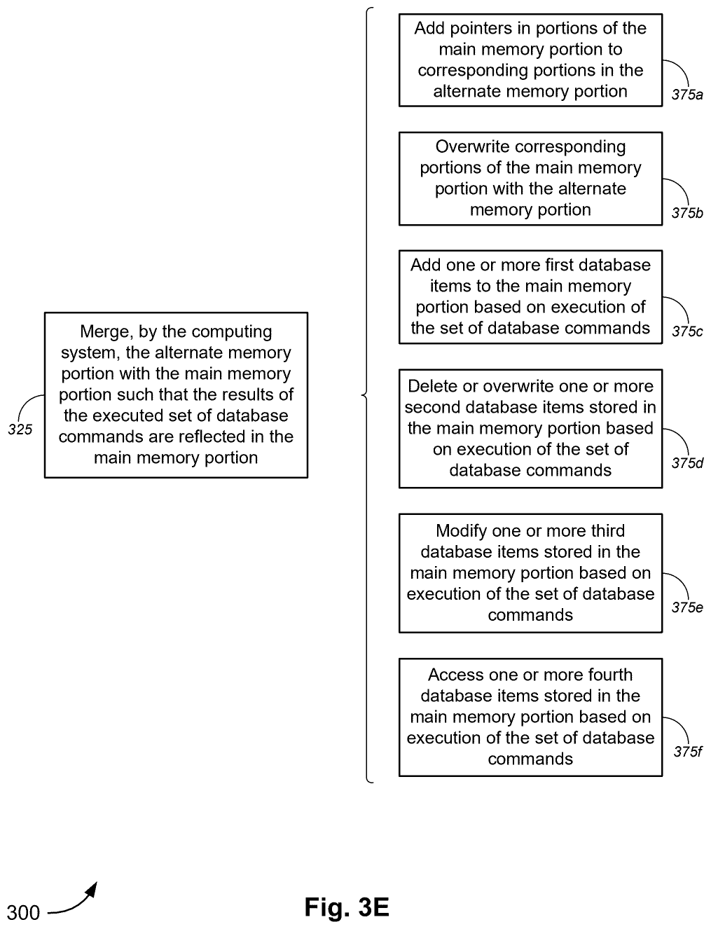

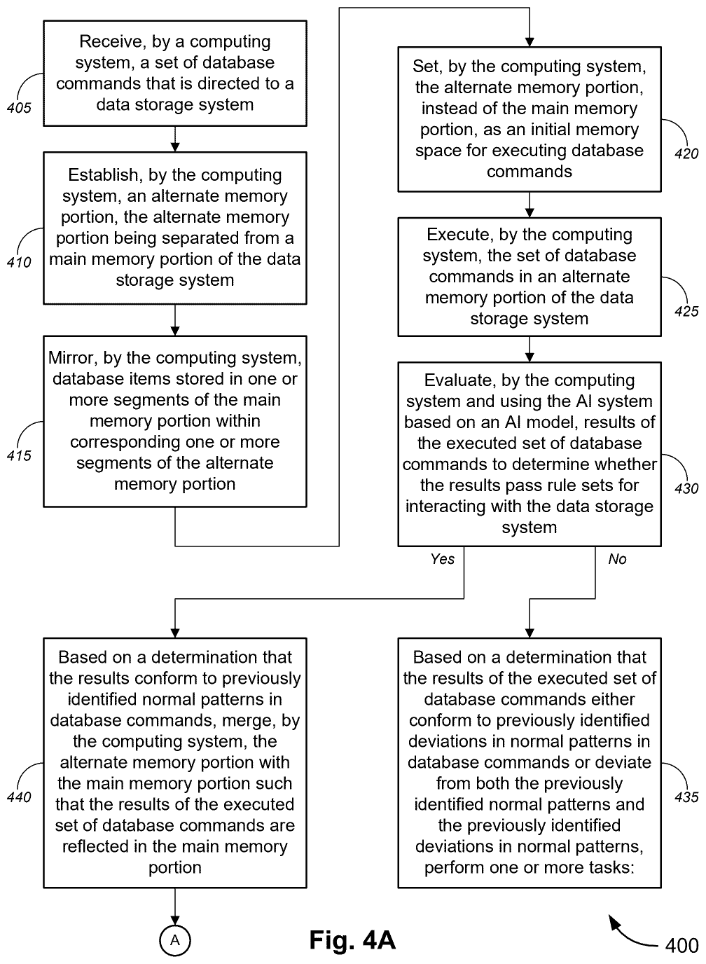

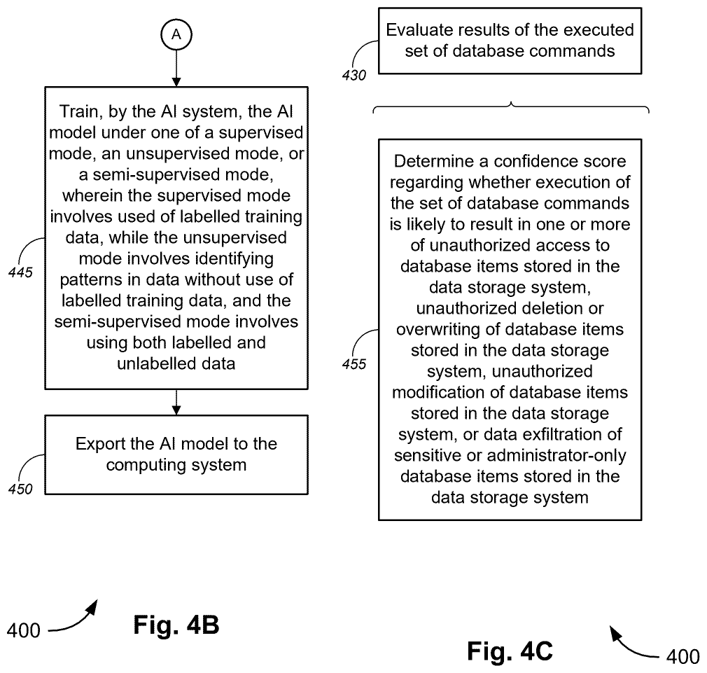

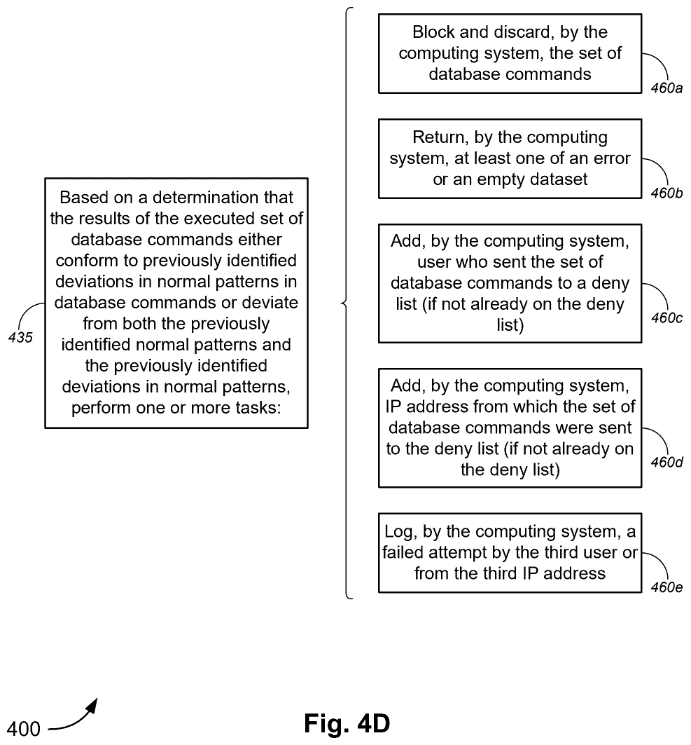

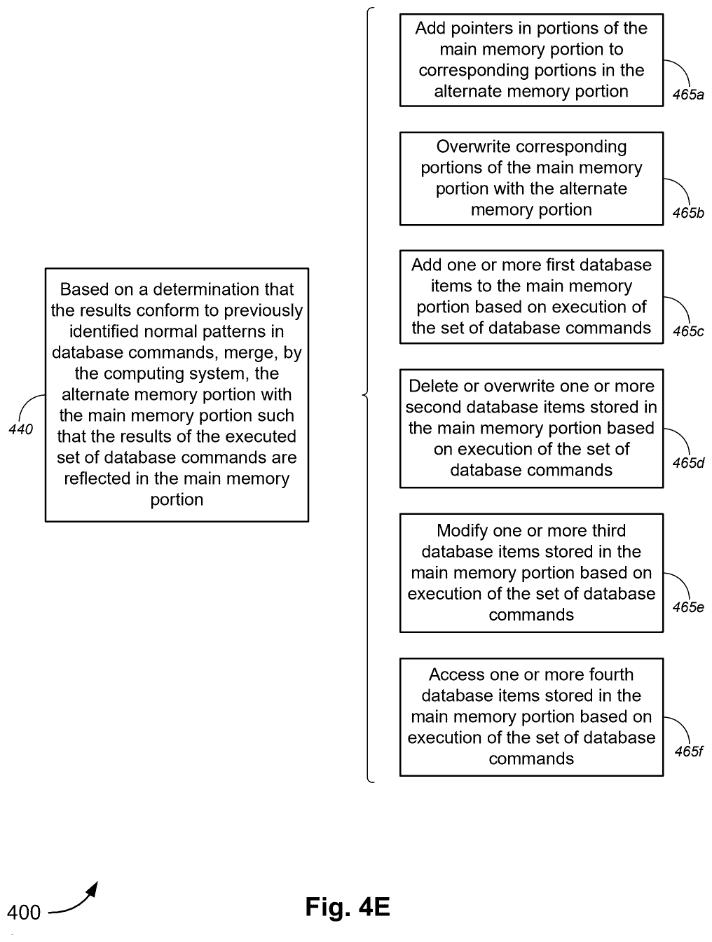

In operation, computing system 105a, computing system 105b, data storage system 115, and/or AI system 130 (collectively, “computing system”) may perform methods for implementing an alternate memory space(s) for evaluating database commands, as described in detail with respect to FIGS. 2-4. For example, the example sequence flow 200 as described below with respect to FIG. 2, the example method 300 as described below with respect to FIGS. 3A-3E, and the example method 400 as described below with respect to FIGS. 4A-4E may be applied with respect to the operations of system 100 of FIG. 1.

FIG. 2 depicts an example sequence flow 200 for implementing an alternate memory space for evaluating database commands, in accordance with various embodiments. Although FIG. 2 describes an SQL implementation of the alternate memory space, the various embodiments are not limited to SQL implementation, and any suitable database system (whether relational database system or non-relational database system) may be used. In some embodiments, client device 205, application server(s) 210, SQL database system 215, and result evaluator or AI system 220 of FIG. 2 may be similar, if not identical, to the user devices 180a-180n, computing system 105a or 105b, data storage system 115, and AI system 130, respectively, of system 100 of FIG. 1, and the description of these components of system 100 of FIG. 1 are similarly applicable to the corresponding components of FIG. 2.

With reference to FIG. 2, client device 205 may send user input 225 to application server(s) 210 (e.g., web frontend server(s) and/or web backend server(s), or the like), the user input 225 including one or more of a request for accessing or retrieving database items stored in the SQL database system 215, a request for adding database items stored in the SQL database system 215, a request for editing or modifying database items stored in the SQL database system 215, and/or a request for deleting or overwriting database items stored in the SQL database system 215, and/or the like. The application server(s) 210 generates SQL command(s) 230 based on the user input 225, and sends the SQL commands 230 to SQL database system 215. The SQL database 215, using result evaluator 220 (which may include an AI system) to perform evaluation processes 235. The evaluation processes 235 may include executing the SQL command(s) 230 in a memory overlay (e.g., alternate memory portion 150a-150x of FIG. 1, or the like) of the SQL database system 215, and evaluating results of the SQL command(s) compared with one or more rule sets (e.g., rule set(s) 165a-165z of FIG. 1, or the like). In some cases, evaluating the results of the SQL command(s) may be implemented by using the AI system based on trained AI model(s) 220a. In some examples, a rule-based and/or an ML-based AI system may be used to determine whether the results of the SQL command(s) pass the one or more rules sets, e.g., by determining whether the results of the executed set of database commands either conform to previously identified normal patterns in database commands, conform to previously identified deviations in normal patterns in database commands, or deviate from both the previously identified normal patterns and the previously identified deviations in normal patterns, or the like. In examples, ML algorithms (e.g., deep learning algorithms such as convolutional neural networks (“CNNs”), etc.) may be used to identify normal patterns as well as deviations in normal patterns in database commands, as well as conformance or deviations from those identified normal patterns. When a rule is established indicating that database commands should conform to the identified normal patterns, rule-based algorithms may be used to determine whether the SQL commands pass such a rule (e.g., whether the SQL commands conform or deviate from those identified normal patterns, etc.). If the results of the SQL command(s) pass the rule sets, evaluation processes 235 may include merging the memory overlay with a main memory (e.g., main memory portion 145 of FIG. 1, or the like) of the SQL database system 215. On the other hand, if the results of the SQL command(s) do not pass the rule sets, evaluation processes 235 may include block or discarding the SQL command(s). The SQL database system 215 may subsequently send SQL result(s) 260 to the application server(s) 210. The SQL result(s) 260 may include the results of the SQL command(s) that pass the rule sets (in the former case) or an indication that an error occurred when attempting to execute the SQL command(s) (in the latter case). The application server(s) 210 then sends a response 265 to the client device 205 based on the SQL result(s) 260.

In some examples, the rule sets include primary rule sets defining baseline rules (which may be established by one or more users) and secondary rule sets defining rules that are determined (e.g., created or refined over time) by the AI system (e.g., by ML algorithms) based on user interactions with the computing system or the data storage system. For instance, the ML algorithms may be used to perform rule learning, which is a process for creating rules from data and/or existing rules or models. Rule learning can involve different types of inferences, including inductive, deductive, and analogical reasoning. Alternatively or additionally, in some cases, the rule sets further include priority rule sets defining priority rules that are prevented from being overwritten and have priority over other rules in the primary rule sets or the secondary rule sets. Alternatively or additionally, in examples, the rule sets (further) include at least one of: (1) a set of allow list rules indicating that one or more first users and/or users sending database commands from one or more first Internet Protocol (“IP”) addresses have permissions to access, overwrite, delete, and modify database items stored in the data storage system; (2) a set of deny list rules indicating that one or more second users and/or users sending database commands from one or more second IP addresses do not have permissions to access, overwrite, delete, or modify database items stored in the data storage system; (3) a set of rules preventing unauthorized deletion or overwriting of database items from the data storage system; (4) a set of rules preventing unauthorized access of database items from the data storage system; (5) a set of rules preventing unauthorized modification of database items stored in the data storage system; or a set of rules preventing data exfiltration of sensitive or administrator-only database items from the data storage system. “Data exfiltration,” as used herein, may refer to unauthorized transfer of information from an information storage system, or the like. In examples, the allow list rules and/or the deny list rules may be established by a developer or a database administrator, or the like.

FIGS. 3A-3E (collectively, “FIG. 3”) depict flow diagrams illustrating an example method 300 for implementing an alternate memory space for evaluating database commands, in accordance with various embodiments. Method 300 of FIG. 3A continues onto FIG. 3B following the circular marker denoted, “A.” Method 300 of FIG. 3C continues onto FIG. 3A following the circular marker denoted, “B.”

In the non-limiting embodiment of FIG. 3A, method 300, at operation 305, may include receiving, by a computing system, a set of database commands that is directed to a data storage system. In examples, the computing system may receive the set of database commands at an application level, at a database level (e.g., an SQL level), or at a driver level (e.g., an open database connectivity (“ODBC”) driver level or a Java database connectivity (“JDBC”) driver level, or the like). At operation 310, method 300 may include executing, by the computing system, the set of database commands in an alternate memory portion of the data storage system, the alternate memory portion being separated from a main memory portion of the data storage system. Method 300 may further include, at operation 315, evaluating, by the computing system, results of the executed set of database commands to determine whether the results pass rule sets for interacting with the data storage system. If not, method 300 may continue onto the process at operation 320. If so, method 300 may continue onto the process at operation 325.

In some examples, the computing system includes at least one of a data storage orchestrator, a database management system, a database administrator system, a memory manager, a server, a cloud computing system, or a distributed computing system, and/or the like. In some instances, the set of database commands includes one of SQL commands or a shell script that contains a sequence of commands, or the like. As used herein, a “shell script” may refer to a text file containing a sequence of commands, where “shell” refers to a particular command-line user interface that may be used to communicate with an operating system (“OS”) kernel (e.g., a Linux kernel, or the like). In some cases, each database command includes at least one of one or more database statements or one or more database queries, or the like. As used herein, “database statements” may refer to database objects that may control transactions, program flow, connections, sessions, and/or diagnostics, and may have a persistent effect on schema and data, while “database queries” may refer to an element of the SQL that retrieves data based on specific criteria. In examples, the rule sets for interacting with the data storage system define safeguards or guardrails around at least one of database queries, database statements, or executed code, and/or the like.

At operation 320, method 300 may include, based on a determination that the results do not pass the rule sets for interacting with the data storage system, performing, by the computing system, at least one of: (a) blocking and discarding, by the computing system, the set of database commands (at operation 330a); (b) returning, by the computing system, at least one of an error or an empty dataset, or the like (at operation 330b); (c) adding, by the computing system, a user who sent the set of database commands to a deny list (if not already on the deny list) indicating that the user does not have permissions to access, delete, or modify database items stored in the data storage system (at operation 330c); (d) adding, by the computing system, an IP address to the deny list indicating that users who send database commands from the IP address do not have permissions to access, delete, or modify database items stored in the data storage system (at operation 330d); or (c) logging, by the computing system, a failed attempt by the user or from the IP address, based on the results of the executed set of database commands not passing the rule sets (at operation 330c); and/or the like.

At operation 325, method 300 may include, based on a determination that the results pass the rule sets for interacting with the data storage system, merging, by the computing system, the alternate memory portion with the main memory portion such that the results of the executed set of database commands are reflected in the main memory portion. In some cases, method 300 may continue onto the process at operation 335 in FIG. 3B following the circular marker denoted, “A.” At operation 335 in FIG. 3B (following the circular marker denoted, “A”), method 300 may include training, by an AI system, an AI model under one of a supervised mode, an unsupervised mode, or a semi-supervised mode, or the like. In examples, the supervised mode involves use of labeled training data, while the unsupervised mode involves identifying patterns in data without use of labeled training data, and the semi-supervised mode involves using both labeled and unlabeled data. Method 300 may further include exporting the AI model to the computing system (at operation 340).

With reference to the non-limiting example of FIG. 3C, method 300 may further include establishing, by the computing system, the alternate memory portion (at operation 345). At operation 350, method 300 may include mirroring, by the computing system, database items stored in one or more segments of the main memory portion within corresponding one or more segments of the alternate memory portion. Method 300, at operation 355, may include setting, by the computing system, the alternate memory portion, instead of the main memory portion, as an initial memory space for executing database commands. Method 300 may continue onto the process at operation 305 in FIG. 3A following the circular marker denoted, “B,” where, in some cases, one or more of the processes at operations 305-340 may be implemented.

Referring to FIG. 3D, in an example, evaluating the results of the executed set of database commands (at operation 315) may include determining a confidence score regarding whether execution of the set of database commands is likely to result in one or more of unauthorized access to database items stored in the data storage system, unauthorized deletion or overwriting of database items stored in the data storage system, unauthorized modification of database items stored in the data storage system, or data exfiltration of sensitive or administrator-only database items stored in the data storage system, and/or the like (at operation 360). In some examples, determining the confidence score is based on a sensitivity weighting value that is adjustable by a database administrator via a database administrator user interface (“UI”).

In another example, evaluating the results of the executed set of database commands (at operation 315) may alternatively or additionally include using an AI system to evaluate, using an AI model, the results of the executed set of database commands, to determine whether the results of the executed set of database commands either conform to previously identified normal patterns in database commands, conform to previously identified deviations in normal patterns in database commands, or deviate from both the previously identified normal patterns and the previously identified deviations in normal patterns (at operation 365). In other words, AI analytics may be used to enforce protections based on previous behavior and role definitions. In an example, a normal pattern that the AI analytics may identify may be queries being received from a first user at particular times, locations, etc., but a change in pattern is identified, which the system may flag as a potential attack by another user using the first user's IP address and/or user device, or the like. This may cause the system to throw an exception, flag, or error.

Method 300 may further include, based on a determination that the results of the executed set of database commands either conform to previously identified deviations in normal patterns in database commands or deviate from both the previously identified normal patterns and the previously identified deviations in normal patterns, returning at least one of an error or an empty dataset (at operation 370).

In some examples, the rule sets include primary rule sets defining baseline rules and secondary rule sets defining rules that are determined by the AI system based on user interactions with the computing system or the data storage system. Alternatively or additionally, in some cases, the rule sets further include priority rule sets defining priority rules that are prevented from being overwritten and have priority over other rules in the primary rule sets or the secondary rule sets. Alternatively or additionally, in examples, the rule sets (further) include at least one of: (1) a set of allow list rules indicating that one or more first users and/or users sending database commands from one or more first Internet Protocol (“IP”) addresses have permissions to access, overwrite, delete, and modify database items stored in the data storage system; (2) a set of deny list rules indicating that one or more second users and/or users sending database commands from one or more second IP addresses do not have permissions to access, overwrite, delete, or modify database items stored in the data storage system; (3) a set of rules preventing unauthorized deletion or overwriting of database items from the data storage system; (4) a set of rules preventing unauthorized access of database items from the data storage system; (5) a set of rules preventing unauthorized modification of database items stored in the data storage system; or a set of rules preventing data exfiltration of sensitive or administrator-only database items from the data storage system.

Turning to the non-limiting example of FIG. 3E, in an example, merging the alternate memory portion with the main memory portion such that the results of the executed set of database commands are reflected in the main memory portion (at operation 325) may include adding pointers in portions of the main memory portion to corresponding portions in the alternate memory portion (at operation 375a). Alternatively or additionally, in another example, merging the alternate memory portion with the main memory portion (at operation 325) may include overwriting corresponding portions of the main memory portion with the alternate memory portion (at operation 375b). Alternatively or additionally, in yet another example, merging the alternate memory portion with the main memory portion (at operation 325) may include adding one or more first database items to the main memory portion based on execution of the set of database commands (at operation 375c). Alternatively or additionally, in still another example, merging the alternate memory portion with the main memory portion (at operation 325) may include deleting or overwriting one or more second database items stored in the main memory portion based on execution of the set of database commands (at operation 375d). Alternatively or additionally, in another example, merging the alternate memory portion with the main memory portion (at operation 325) may include modifying one or more third database items stored in the main memory portion based on execution of the set of database commands (at operation 375c). Alternatively or additionally, in yet another example, merging the alternate memory portion with the main memory portion (at operation 325) may include accessing one or more fourth database items stored in the main memory portion based on execution of the set of database commands (at operation 375f).

FIGS. 4A-4E (collectively, “FIG. 4”) depict flow diagrams illustrating another example method 400 for implementing an alternate memory space for evaluating database commands, in accordance with various embodiments. Method 400 of FIG. 4A continues onto FIG. 4B following the circular marker denoted, “A.”

In the non-limiting embodiment of FIG. 4A, method 400, at operation 405, may include receiving, by a computing system, a set of database commands that is directed to a data storage system. At operation 410, method 400 may include establishing, by the computing system, an alternate memory portion in the data storage system, the alternate memory portion being separated from a main memory portion of the data storage system. Method 400 may further include mirroring, by the computing system, database items stored in one or more segments of the main memory portion within corresponding one or more segments of the alternate memory portion (at operation 415). Method 400 may further include, at operation 420, setting, by the computing system, the alternate memory portion, instead of the main memory portion, as an initial memory space for executing database commands. At operation 425, method 400 may include executing, by the computing system, the set of database commands in an alternate memory portion of the data storage system. Method 400 may further include, at operation 430, evaluating, by the computing system and using the AI system based on an AI model, results of the executed set of database commands to determine whether the results pass rule sets for interacting with the data storage system, by determining whether the results of the executed set of database commands either conform to previously identified normal patterns in database commands, conform to previously identified deviations in normal patterns in database commands, or deviate from both the previously identified normal patterns and the previously identified deviations in normal patterns. If not, method 400 may continue onto the process at operation 435. If so, method 400 may continue onto the process at operation 440.

In some examples, the computing system includes at least one of a data storage orchestrator, a database management system, a database administrator system, a memory manager, a server, a cloud computing system, or a distributed computing system, and/or the like. In some instances, the set of database commands includes one of SQL commands or a shell script that contains a sequence of commands, or the like. In some cases, each database command includes at least one of one or more database statements or one or more database queries, or the like.

In examples, the rule sets for interacting with the data storage system define safeguards or guardrails around at least one of database queries, database statements, or executed code, and/or the like. In some examples, the rule sets include primary rule sets defining baseline rules and secondary rule sets defining rules that are determined by the AI system based on user interactions with the computing system or the data storage system. Alternatively or additionally, in some cases, the rule sets further include priority rule sets defining priority rules that are prevented from being overwritten and have priority over other rules in the primary rule sets or the secondary rule sets. Alternatively or additionally, in examples, the rule sets (further) include at least one of: (1) a set of allow list rules indicating that one or more first users and/or users sending database commands from one or more first IP addresses have permissions to access, overwrite, delete, and modify database items stored in the data storage system; (2) a set of deny list rules indicating that one or more second users and/or users sending database commands from one or more second IP addresses do not have permissions to access, overwrite, delete, or modify database items stored in the data storage system; (3) a set of rules preventing unauthorized deletion or overwriting of database items from the data storage system; (4) a set of rules preventing unauthorized access of database items from the data storage system; (5) a set of rules preventing unauthorized modification of database items stored in the data storage system; or a set of rules preventing data exfiltration of sensitive or administrator-only database items from the data storage system.

At operation 435, with reference to FIGS. 4A and 4D, method 400 may include, based on a determination that the results of the executed set of database commands either conform to previously identified deviations in normal patterns in database commands or deviate from both the previously identified normal patterns and the previously identified deviations in normal patterns, performing, by the computing system, at least one of: (a) blocking and discarding, by the computing system, the set of database commands (at operation 460a); (b) returning, by the computing system, at least one of an error or an empty dataset, or the like (at operation 460b); (c) adding, by the computing system, a user who sent the set of database commands to a deny list (if not already on the deny list) indicating that the user does not have permissions to access, delete, or modify database items stored in the data storage system (at operation 460c); (d) adding, by the computing system, an IP address to the deny list indicating that users who send database commands from the IP address do not have permissions to access, delete, or modify database items stored in the data storage system (at operation 460d); or (c) logging, by the computing system, a failed attempt by the user or from the IP address, based on the results of the executed set of database commands not passing the rule sets (at operation 460c); and/or the like.

Turning back to FIG. 4A, at operation 440, method 400 may include, based on a determination that the results pass the rule sets for interacting with the data storage system, merging, by the computing system, the alternate memory portion with the main memory portion such that the results of the executed set of database commands are reflected in the main memory portion. Referring to the non-limiting example of FIG. 4E, in an example, merging the alternate memory portion with the main memory portion such that the results of the executed set of database commands are reflected in the main memory portion (at operation 440) may include adding pointers in portions of the main memory portion to corresponding portions in the alternate memory portion (at operation 465a). Alternatively or additionally, in another example, merging the alternate memory portion with the main memory portion (at operation 440) may include overwriting corresponding portions of the main memory portion with the alternate memory portion (at operation 465b). Alternatively or additionally, in yet another example, merging the alternate memory portion with the main memory portion (at operation 440) may include adding one or more first database items to the main memory portion based on execution of the set of database commands (at operation 465c). Alternatively or additionally, in still another example, merging the alternate memory portion with the main memory portion (at operation 440) may include deleting or overwriting one or more second database items stored in the main memory portion based on execution of the set of database commands (at operation 465d). Alternatively or additionally, in another example, merging the alternate memory portion with the main memory portion (at operation 440) may include modifying one or more third database items stored in the main memory portion based on execution of the set of database commands (at operation 465c). Alternatively or additionally, in yet another example, merging the alternate memory portion with the main memory portion (at operation 440) may include accessing one or more fourth database items stored in the main memory portion based on execution of the set of database commands (at operation 465f).

Turning back to FIG. 4A, method 400 may continue onto the process at operation 435 in FIG. 4B following the circular marker denoted, “A.” At operation 445 in FIG. 4B (following the circular marker denoted, “A”), method 400 may include training, by an AI system, an AI model under one of a supervised mode, an unsupervised mode, or a semi-supervised mode, or the like. In examples, the supervised mode involves use of labeled training data, while the unsupervised mode involves identifying patterns in data without use of labeled training data, and the semi-supervised mode involves using both labeled and unlabeled data. Method 400 may further include exporting the AI model to the computing system (at operation 450).

Referring to FIG. 4C, in an example, evaluating the results of the executed set of database commands (at operation 430) may include determining a confidence score regarding whether execution of the set of database commands is likely to result in one or more of unauthorized access to database items stored in the data storage system, unauthorized deletion or overwriting of database items stored in the data storage system, unauthorized modification of database items stored in the data storage system, or data exfiltration of sensitive or administrator-only database items stored in the data storage system, and/or the like (at operation 455). In some examples, determining the confidence score is based on a sensitivity weighting value that is adjustable by a database administrator via a database administrator UI.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

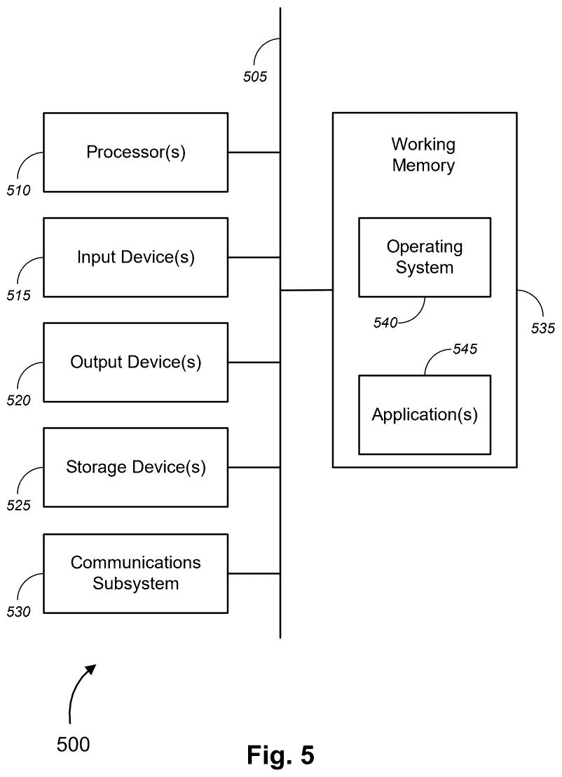

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a and 105b or application server(s) 210, data storage system 115 or SQL database system 215, AI systems 130 and 220, user devices 180a-180n or client device 205, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a and 105b or application server(s) 210, data storage system 115 or SQL database system 215, AI systems 130 and 220, user devices 180a-180n or client device 205, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for case of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, a set of database commands that is directed to a data storage system;
executing, by the computing system, the set of database commands in an alternate memory portion of the data storage system, the alternate memory portion being separated from a main memory portion of the data storage system;
evaluating, by the computing system, results of the executed set of database commands to determine whether the results pass rule sets for interacting with the data storage system; and
performing one of:
based on a determination that the results pass the rule sets for interacting with the data storage system, merging, by the computing system, the alternate memory portion with the main memory portion such that the results of the executed set of database commands are reflected in the main memory portion; or
based on a determination that the results do not pass the rule sets for interacting with the data storage system, blocking and discarding, by the computing system, the set of database commands.

2. The method of claim 1, wherein the computing system comprises at least one of a data storage orchestrator, a database management system, a database administrator system, a memory manager, a server, a cloud computing system, or a distributed computing system.

3. The method of claim 1, wherein the set of database commands comprises one of structured query language (“SQL”) commands or a shell script that contains a sequence of commands, wherein each database command includes at least one of one or more database statements or one or more database queries.

4. The method of claim 1, wherein the rule sets for interacting with the data storage system define safeguards around at least one of database queries, database statements, or executed code.

5. The method of claim 1, wherein evaluating results of the executed set of database commands comprises determining a confidence score regarding whether execution of the set of database commands is likely to result in one or more of unauthorized access to database items stored in the data storage system, unauthorized deletion or overwriting of database items stored in the data storage system, unauthorized modification of database items stored in the data storage system, or data exfiltration of sensitive or administrator-only database items stored in the data storage system, wherein determining the confidence score is based on a sensitivity weighting value that is adjustable by a database administrator via a database administrator user interface (“UI”).

6. The method of claim 1, wherein the rule sets include baseline rules including at least one of:
a set of allow list rules indicating that one or more first users and/or users sending database commands from one or more first Internet Protocol (“IP”) addresses have permissions to access, overwrite, delete, and modify database items stored in the data storage system;
a set of deny list rules indicating that one or more second users and/or users sending database commands from one or more second IP addresses do not have permissions to access, overwrite, delete, or modify database items stored in the data storage system;
a set of rules preventing unauthorized deletion or overwriting of database items from the data storage system;
a set of rules preventing unauthorized access of database items from the data storage system;
a set of rules preventing unauthorized modification of database items stored in the data storage system; or
a set of rules preventing data exfiltration of sensitive or administrator-only database items from the data storage system.

7. The method of claim 6, wherein the rule sets comprise primary rule sets defining the baseline rules and secondary rule sets defining rules that are determined by an artificial intelligence (“AI”) system based on user interactions with the computing system or the data storage system.

8. The method of claim 7, wherein determining whether the results pass rule sets for interacting with the data storage system comprises using the AI system to determine, using an AI model, whether the results of the executed set of database commands pass the secondary rule sets, to determine whether the results of the executed set of database commands either conform to identified normal patterns in database commands, conform to identified deviations in normal patterns in database commands, or deviate from both the identified normal patterns and the identified deviations in normal patterns.

9. The method of claim 8, further comprising:
based on a determination that the results of the executed set of database commands either conform to the identified deviations in normal patterns in database commands or deviate from both the identified normal patterns and the identified deviations in normal patterns, returning at least one of an error or an empty dataset.

10. The method of claim 8, further comprising:
training, by the AI system, the AI model under one of a supervised mode, an unsupervised mode, or a semi-supervised mode, wherein the supervised mode involves use of labeled training data, while the unsupervised mode involves identifying patterns in data without use of labeled training data, and the semi-supervised mode involves using both labeled and unlabeled data; and
exporting the AI model to the computing system.

11. The method of claim 7, wherein the rule sets further comprise priority rule sets defining priority rules that are prevented from being overwritten and have priority over other rules in the primary rule sets or the secondary rule sets.

12. The method of claim 1, wherein the alternate memory portion is a mirrored memory of at least portions of the main memory portion, wherein merging the alternate memory portion with the main memory portion includes one or more of:
adding pointers in portions of the main memory portion to corresponding portions in the alternate memory portion; or
overwriting corresponding portions of the main memory portion with the alternate memory portion.

13. The method of claim 1, wherein merging the alternate memory portion with the main memory portion includes one or more of:
adding one or more first database items to the main memory portion based on execution of the set of database commands;
deleting or overwriting one or more second database items stored in the main memory portion based on execution of the set of database commands;
modifying one or more third database items stored in the main memory portion based on execution of the set of database commands; or
accessing one or more fourth database items stored in the main memory portion based on execution of the set of database commands.

14. The method of claim 1, wherein, based on the determination that the results do not pass the rule sets for interacting with the data storage system, further performing one or more of:
based on a determination that a third user who sent the set of database commands is not currently on a deny list, adding, by the computing system, the third user to the deny list indicating that the third user does not have permission to access, delete, or modify database items stored in the data storage system;
based on a determination that a third IP address from which the set of database commands were sent is not currently on the deny list, adding, by the computing system, the third IP address to the deny list indicating that users sending database commands from the third IP address do not have permissions to access, delete, or modify database items stored in the data storage system; or
logging, by the computing system, a failed attempt by the third user or from the third IP address, based on the results of the executed set of database commands not passing the rule sets.

15. The method of claim 1, further comprising, prior to receiving the set of database commands:
establishing, by the computing system, the alternate memory portion;
mirroring, by the computing system, database items stored in one or more segments of the main memory portion within corresponding one or more segments of the alternate memory portion; and
setting, by the computing system, the alternate memory portion, instead of the main memory portion, as an initial memory space for executing database commands.

16. The method of claim 15, wherein establishing the alternate memory portion comprises establishing a plurality of alternate memory portions, wherein mirroring the database items stored in the main memory portion comprises mirroring the database items stored in the main memory portion in each of the plurality of alternate memory portions, wherein the plurality of alternate memory portions are set to execute a corresponding plurality of database commands either in parallel or sequentially, wherein the method further comprises:
determining, by the computing system, whether merging a first alternate memory portion with the main memory portion conflicts with merging a second alternate memory portion with the main memory portion; and
based on a determination that merging a first alternate memory portion with the main memory portion conflicts with merging a second alternate memory portion with the main memory portion, performing the following:
executing, by the computing system, a set of database commands that is received first;
based on a determination that results of the first-received set of database commands pass the rule sets, merging, by the computing system, a corresponding one of the first or second memory portion with the main 17 memory portion;
executing a set of database commands that is received second; and
based on a determination that results of the second-received set of database commands pass the rule sets, merging the other of the first or second memory portion with the merged main memory portion.

17. A system, comprising:
an artificial intelligence (“AI”) system; and
a computing system, comprising:
a processing system; and
memory coupled to the processing system, the memory comprising computer executable instructions that, when executed by the processing system, causes the system to perform operations comprising:
receiving a set of database commands that is directed to a data storage system;
executing the set of database commands in an alternate memory portion of the data storage system, the alternate memory portion being separated from a main memory portion of the data storage system;
evaluating, using the AI system and based on an AI model, results of the executed set of database commands to determine whether the results pass rule sets for interacting with the data storage system; and
performing one of:
based on a determination that the results pass the rule sets for interacting with the data storage system, merging, by the computing system, the alternate memory portion with the main memory portion such that the results of the executed set of database commands are reflected in the main memory portion; or
based on a determination that the results do not pass the rule sets for interacting with the data storage system, blocking and discarding, by the computing system, the set of database commands.

18. The system of claim 17, wherein evaluating results of the executed set of database commands comprises using the AI system to evaluate, using the AI model, the results of the executed set of database commands, to determine whether the results of the executed set of database commands either conform to previously identified normal patterns in database commands, conform to previously identified deviations in normal patterns in database commands, or deviate from both the previously identified normal patterns and the previously identified deviations in normal patterns, wherein the operations further comprise:
based on a determination that the results of the executed set of database commands either conform to previously identified deviations in normal patterns in database commands or deviate from both the previously identified normal patterns and the previously identified deviations in normal patterns, returning at least one of an error or an empty dataset.

19. A method, comprising:
receiving, by a computing system, a set of database commands that is directed to a data storage system;
establishing, by the computing system, an alternate memory portion in the data storage system, the alternate memory portion being separated from a main memory portion of the data storage system;
mirroring, by the computing system, database items stored in one or more segments of the main memory portion within corresponding one or more segments of the alternate memory portion;
setting, by the computing system, the alternate memory portion, instead of the main memory portion, as an initial memory space for executing database commands;
executing, by the computing system, the set of database commands in the alternate memory portion of the data storage system;
evaluating, by the computing system and using the AI system based on an AI model, results of the executed set of database commands to determine whether the results pass rule sets for interacting with the data storage system, by determining whether the results of the executed set of database commands either conform to previously identified normal patterns in database commands, conform to previously identified deviations in normal patterns in database commands, or deviate from both the previously identified normal patterns and the previously identified deviations in normal patterns; and
performing one of:
based on a determination that the results conform to previously identified normal patterns in database commands, merging, by the computing system, the alternate memory portion with the main memory portion such that the results of the executed set of database commands are reflected in the main memory portion; or
based on a determination that the results of the executed set of database commands either conform to previously identified deviations in normal patterns in database commands or deviate from both the previously identified normal patterns and the previously identified deviations in normal patterns, performing at least one of:
blocking and discarding, by the computing system, the set of database commands; or
returning, by the computing system, at least one of an error or an empty dataset.

20. The method of claim 19, wherein evaluating results of the executed set of database commands comprises determining, using the AI system and based on the AI model, a confidence score regarding whether execution of the set of database commands is likely to result in one or more of unauthorized access to database items stored in the data storage system, unauthorized deletion or overwriting of database items stored in the data storage system, unauthorized modification of database items stored in the data storage system, or data exfiltration of sensitive or administrator-only database items stored in the data storage system, wherein the determining the confidence score is based on a sensitivity weighting value that is adjustable by a database administrator via a database administrator user interface (“UI”).
